(19) United States
(12) Patent Application Publication
(10) Pub. No.: US 2007/0119506 A1
(43) Pub. Date: May 31, 2007

(54) Decorative faucet assembly formed of plastic molded onto metal parts

(76) Inventors: Vincent Giagni JR., Rye, NY (US); Hal Weinstein, Alpharetta, GA (US)

Correspondence Address: James W. Badie, Esq.;Stoll, Miskin & Badie, The Empire State Building, 350 Fifth Avenue, Suite 4710, New York, NY, 10118, US

(21) Appl. No.: 11/286,522

(22) Filed: Nov. 25, 2005

(51) Int. Cl. F16K 11/078

(52) U.S. Cl. 137/625.4

(57) ABSTRACT

A faucet assembly is provided having a cylindrical body with a base, a rotatable top, a housing and hot and cold tubes entering the housing. Two plates are positioned in the housing, a stationery plate and a top rotatable plates, the stationery plate having one aperture for cold water, a second aperture for hot water and a third aperture for flow of the water mixture from the housing through a discharge tube connected to the housing. A plastic figurine mounted on top of the cylindrical housing is operatively associated with the rotatable plate to partially or completely open the apertures and control the amounts, and hence, the temperature of the water. Functional parts of the assembly are uniquely formed by integrally molding a plastic onto the metal parts thus also enhancing the appearance of the assembly.

### FIELD OF THE INVENTION

The present invention relates generally to plumbing accessories such as a faucet and faucet assembly, and is particularly related to such faucet assemblies and faucet handles formed by molding, as a unitary structure, a decorative plastic and plastic figurines onto metal parts for operating the faucet handles.

### BACKGROUND OF THE INVENTION

A variety of faucets and faucet handles are commonly used for controlling water flow into sinks, bathtubs, etc. These faucets and faucet handles are often provided in different shapes and are generally made of metals such as, e.g., steel or brass. In order to enhance the aesthetics of these accessories, decorative faucets and faucet handles have been suggested and described in some prior art patents. For example, U.S. Pat. No. 4,876,766 issued to Richard K. Cohen on Oct. 31, 1989 describes a decorative faucet handle for mounting on any conventional faucet stem. The faucet handle may be in a decorative shape such as an inanimate figure, a fish, a frog, a duck, a bird, etc., and is generally made of brass.

Other types of faucets have been described which are aimed at enhancing their appeal to consumers. See, e.g., U.S. Pat. No. 4,353,139 issued to Richard M. Wainwright on Oct. 12, 1982 and U.S. Pat. No. 5,482,078 issued to Thomas Yeh on Jan. 9, 1996. The Yeh patent describes a water faucet-fitting seat terminating in a cow head and includes an electrical circuit pre-programmed to produce the “Moo-Moo” howl of the cow.

A combination toy and faucet fountain is described in U.S. Pat. No. 5,337,956 issued to William C. Crutch on Aug. 16, 1994. The faucet fountain comprises faucet fountain core including a tubular body enclosed by a hollow jacket having a fanciful object molded on its exterior surface. The molded object may be a nose on the face of a clown, and the clown's face is painted on the exterior surface of the jacket, all as shown in FIGS. 1-4 of said patent and described with reference to these figures.

A more recent patent, i.e., U.S. Pat. No. 6,205,598 issued to Ruth Ann Black on Mar. 27, 2001 describes protective covers for covering the knobs and spouts of bathtubs and showers and, in FIG. 3, shows an elephant having a front wall forming its face and ears, and a spout cover shaped into a trunk of the elephant.

Different shaped plumbing accessories are also featured in various design patents such as, e.g., Des. 298,161 issued to Michael A. Garcia on Oct. 18, 1988; Des. 305,926 issued to Michael J. Buther on Feb. 6, 1990; Des. 326,312 and Des. 326,312, both issued to Gail B. Frankel on May 19, 1992; Des. 378,232 issued to Gail B. Frankel on Feb. 25,1997 and U.S. D465,095 issued to Rachelle Siefken on Oct. 29, 2002.

None of the aforementioned patents, and so far as it is known no other patents disclose the use of plastic or plastic toys or figurines which are molded onto metal parts to form a unitary integral structure which serves as the operative part of the faucets and faucet handles.

In our copending application Ser. No. 11/084,171 filed Mar. 21, 2005 we describe a decorative faucet assembly in which a plastic figurine in the form of various recognizable toys is integrally molded with the basic functional metal parts for manipulating the faucet.

It is therefore an object of the present invention to provide faucets and faucet handles formed of plastic and metal molded together to define an operative unitary integral structure designed to manipulate the flow of hot water and cold water.

It is a further object of the present invention to provide faucets and faucet handles formed of plastic figurines molded onto metal to form an operative structure of the assembly which has considerable consumer appeal.

It is also an object of the present invention to provide a faucet assembly utilizing integral plastic-metal faucets similar to our aforementioned copending application but wherein the assembly is more compact and differ in configuration from the faucet assembly described in our said copending application.

The foregoing and other features of the present invention will be more fully comprehended from the ensuing detailed description with reference to the various drawings herein.

### SUMMARY OF THE INVENTION

A decorative faucet assembly is provided in accordance with the present invention in which various parts of the faucet are fabricated from plastic and metal, with the plastic being molded onto the metal to form the different parts. Plastic toy figurine form part of the faucet assembly for functional as well as decorative purposes.

The faucet assembly is in the form of a generally cylindrical barrel-shaped body formed from two half sections which are injection molded and adapted to snap into engagement with each other to form the faucet body portion. The faucet body has a base for securement onto a supporting surface, and a top portion which has a plastic figurine affixed thereon and which can serve as a handle for rotating the top portion of the faucet body. A housing is disposed within the top portion of the faucet body, two inlet ports within said housing are connected to two braided tubes which extend through the plastic body and connect to the inlet ports, one for hot water and the other for cold water. Located within the housing are two plates, a rotatable plate on top of a stationery plate. The stationery plate has three apertures; one for cold water, one for hot water and one for the flow of the mixture. The top rotatable plate has an opening which when rotated serce to align with the apertures in the stationery plate to close the apertures thereon partly or completely. The rotatable plate is operatively associated with a lever which can be activated by turning a figurine attached on top of the cylindrical body to a rotatable handle. After the hot and cold water enter the housing and are mixed therein, the water mixture flows out of an outlet port through to a plastic shielded metal tubing and out of the metal tubing into a discharge vessel.

The plastic-on-metal parts are formed by injection molding or by sonic welding of the joint surfaces of the plastic and metal.

Suitable plastics include polyvinylchloride (PVC), acrylonitrile-butadiene-styrene (ABS) and high impact polystryene.

### BRIEF DESCRIPTION OF THE DRAWINGS

In the drawings, wherein like reference numerals designate like parts:

FIG. 1 is a vertical, partly perspective representation of the external view of the body of the faucet assembly;

FIG. 2 is a view similar to FIG. 1 showing, by arrow, the direction of rotation of the rotatable hot and cold water regulator;

FIG. 3 is a vertical section along the line A-A of FIG. 1 showing the different functional components of the faucet assembly;

FIG. 4 is a partly perspective exterior view of one-half of the body of the faucet assembly;

FIG. 5 is a sectional, partly perspective view of the half body shown in FIG. 4 rotated 180 degrees to show the interior details;

FIG. 6 is a partly perspective view showing the exterior of the other half of the body of the faucet assembly which is formed to mate with the half body shown in FIG. 4 to define the body of the faucet assembly shown in FIG. 1;

FIG. 7 is a sectional, partly perspective view of the half body shown in FIG. 6 rotated 180 degrees to show the interior details;

FIG. 8 is an exploded, partly perspective view of the faucet assembly mounting system;

FIGS. 9 is a vertical section between the lines 9-9 of FIG. 3 showing an exploded view of components of the faucet assembly within the cartridge; and

FIG. 10 is an exploded view of the components shown in FIG. 9 along a cross section of the cartridge, with arrows indicating the position of each of said components in the cartridge assembly.

### DETAILED DESCRIPTION OF THE INVENTION

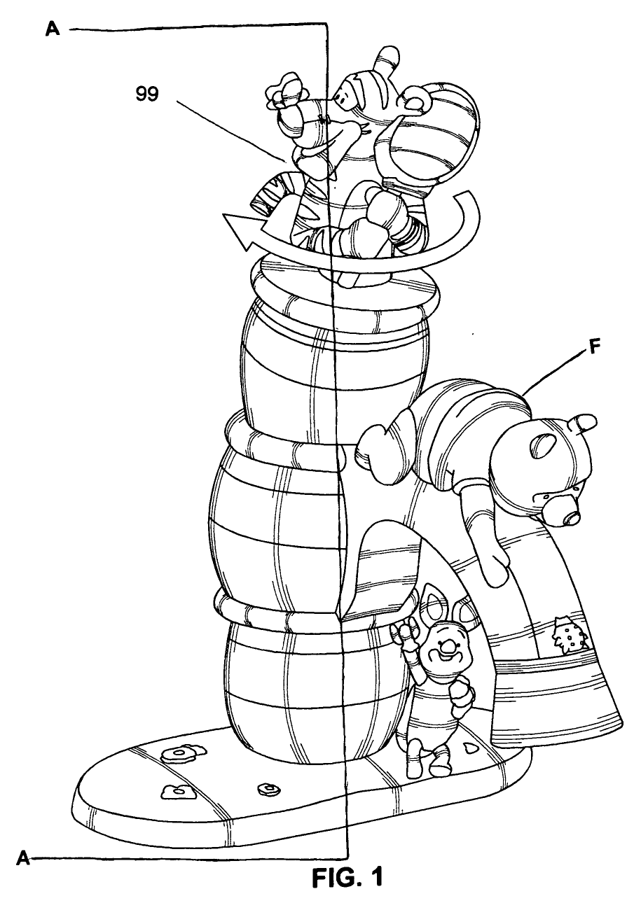

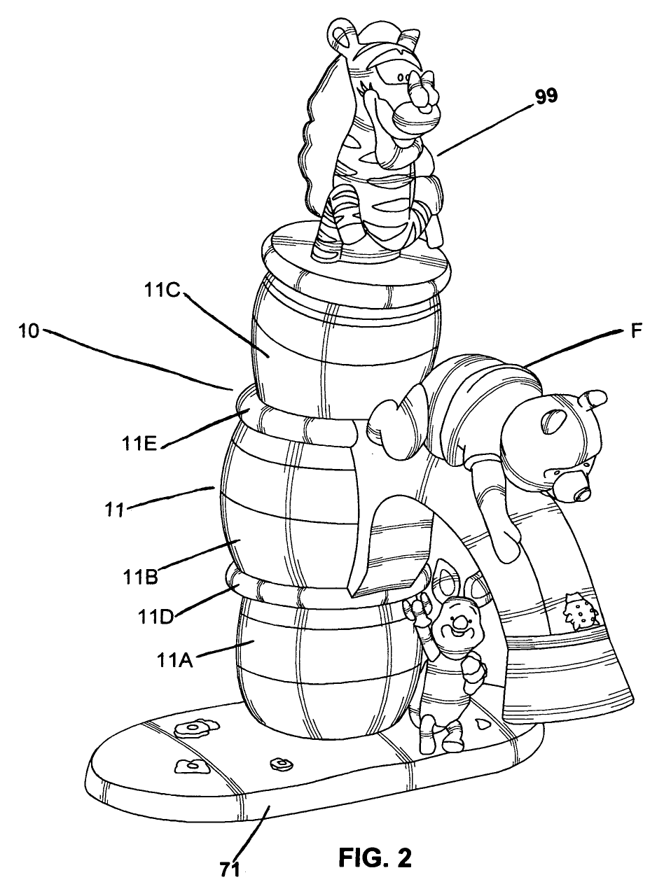

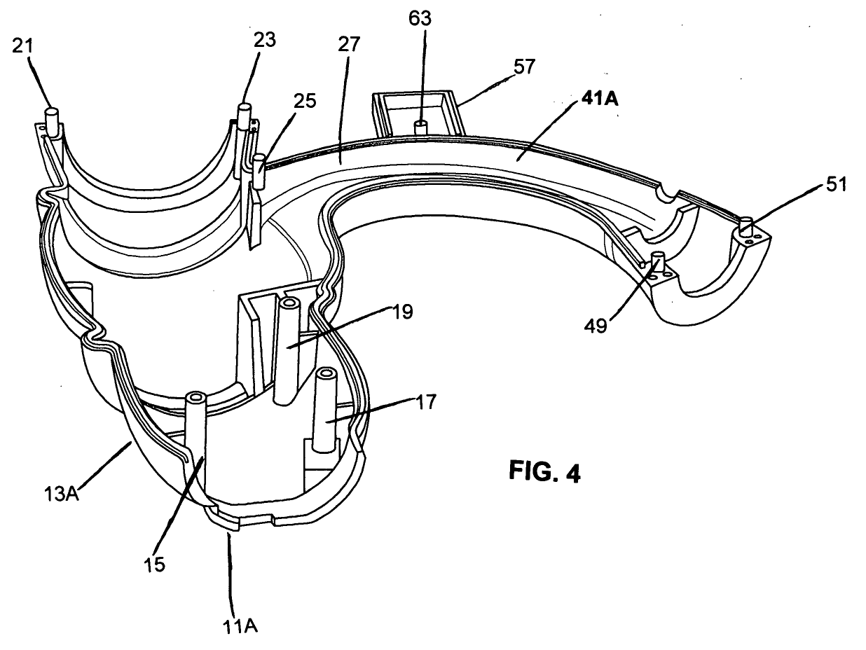

Referring to the drawings, the faucet assembly of the present invention is shown in FIGS. 1 and 2 designated by the reference numeral 10, having a generally cylindrical barrel-shaped body 11 formed of a suitable plastic as will hereinafter be described. The barrel-shaped body 11 as seen exteriorly comprises three portions 11A, 11B and 11C with an annular portion 11D formed integrally between the body portions 11A and 11B, and an annular portion 11E formed integrally between the body portions 11B and 11C. The body portion 11 is conveniently made from two concave half-body sections 13A and 13B as shown in FIGS. 4-7 with the half-body sections adapted to be engaged with one another to form the barrel-shaped body 11 as will hereinafter be described. It must be understood of course that the body 11 need not necessarily be barrel shaped but can be formed in other generally cylindrical configurations. Each of the half bodies of the faucet is fabricated by molding in a suitable mold using known molding methods such as injection molding.

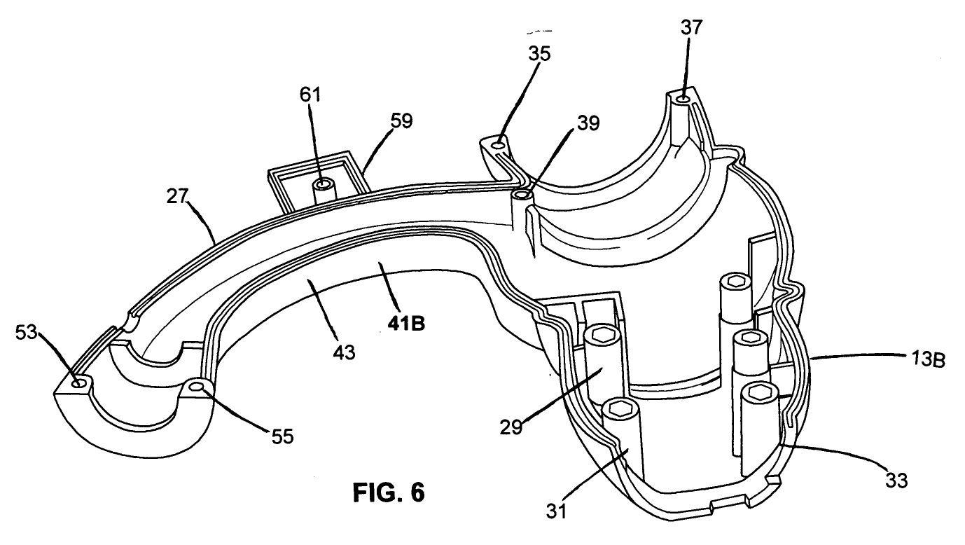

Referring to FIG. 4, there are shown three elongated upstanding grooves 15 17 and 19 located in the lower body portion 11A, and three posts 21, 23 and 25 with the posts 21, 23 peripherally spaced and the post 25 located near the outlet of the faucet tube 27. FIG. 6 is an external view of the half-body portion shown in FIG. 4 rotated upside down 180 degrees about the horizontal axis.

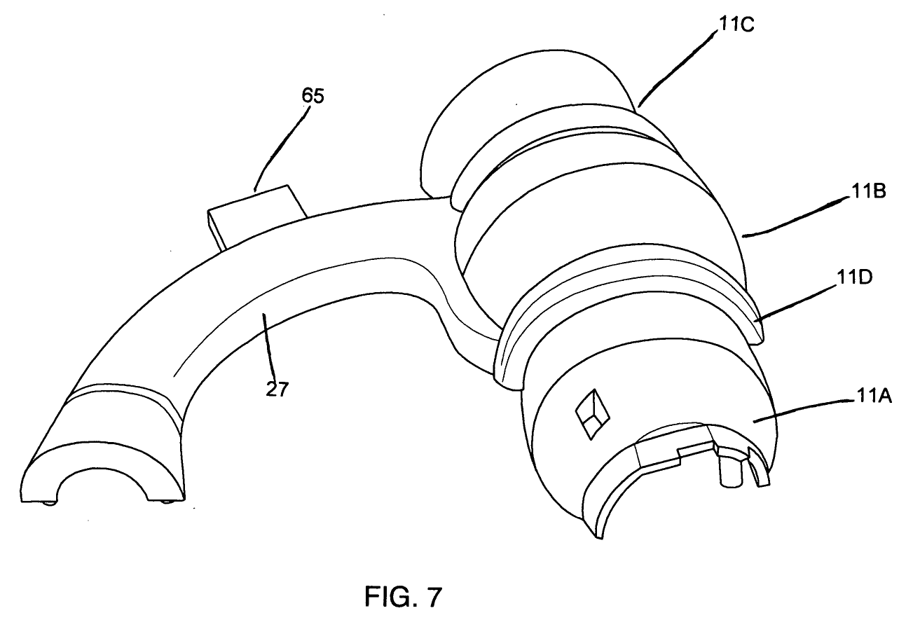

The mating half-body section 13B shown in FIG. 6 comprises two upstanding grooves 29, 31 formed in the lower portion 11A adapted to receive and engage with the posts 17 and 19, respectively, and a third upstanding channeled post 33 adapted to engage the grooved post 15. In order to insure tight engagement of the two half-body sections, the upper portion 11 C has formed therein recessed channels 35, 37 and 39, with the channels 35, 37 peripherally spaced and located to snap into engagement with the posts 21 and 23, and the channel 39 is formed near the inside end of the spout 27 to snap into engagement with the post 25. FIG. 7 is an external view of the half-body portion shown in FIG. 6 rotated upside down 180 degrees about the horizontal axis. Thus, it can be seen from the interior structure of the half body portions 13A, 13B, that when the foregoing grooves and posts are snapped into engagement, there will be formed the body portion 11 of the faucet shown in FIGS. 1 and 2.

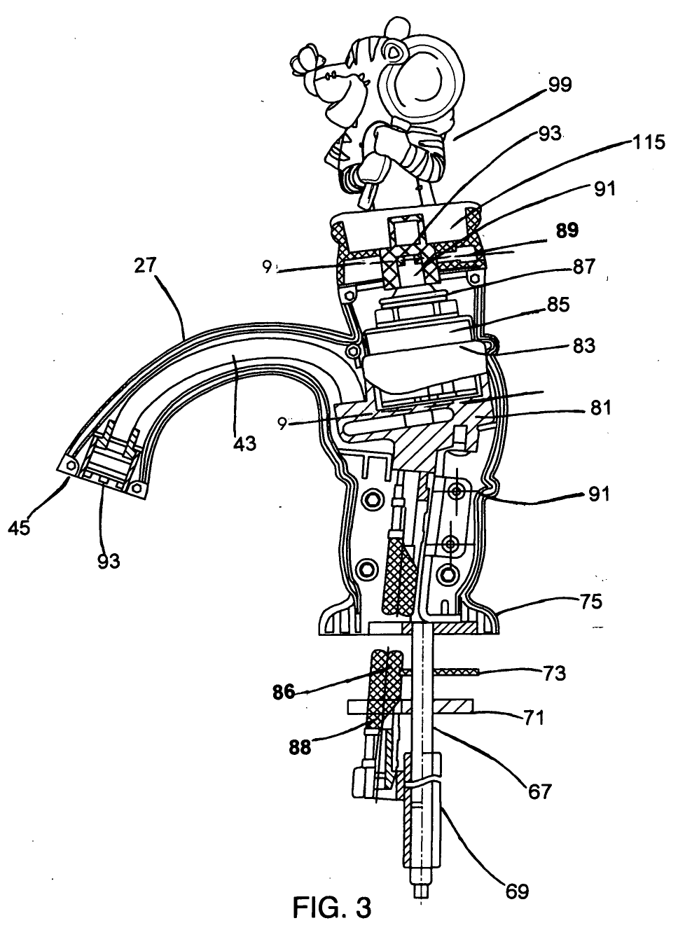

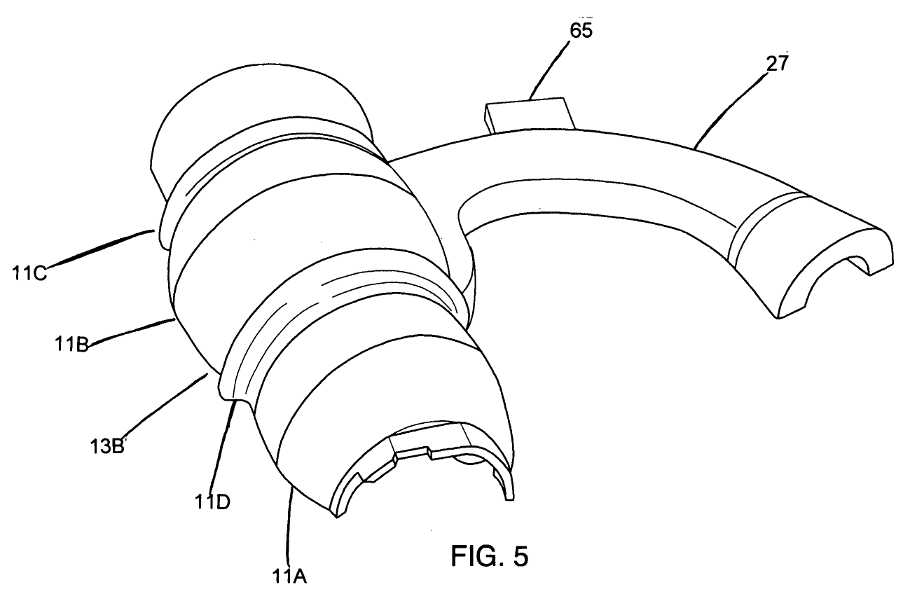

FIGS. 3, 4 and 6 show the interiors of half tubing shells 41A and 41B of the faucet tube 27 having a tubing 43 such as a copper tubing for passage of water from the brass housing 81 into the copper tubing 43 and out of the copper tubing 43 through the spout 27 (see FIG. 3). The half tubing shells 41A, 41B having the posts 49, 51 and the grooves 53, 55 can be engaged with one another when the half-body portions 13A, 13B, and the half tubing shells 41A, 41B are snapped into engagement. On the upper edges of the half tubing shells 41A, 41B there are mounted two oppositely facing plastic plates 57, 59, one having a groove 61 and the other having a post 63 adapted to engage into the groove 61 to form a raised plate 65 as seen in FIG. 5 6. A plastic figurine F having a bottom channel or opening (not shown) can be securely mounted on the upper edge of the plate 65 for decorative purposes (see FIGS. 1 and 2).

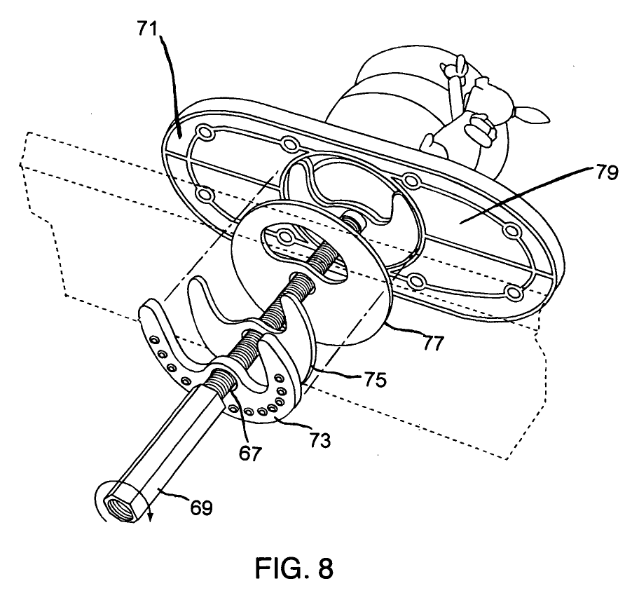

The manner of mounting the faucet assembly is shown in FIG. 8. As shown in FIG. 8, an externally threaded mounting stud 67 with adjustable internally threaded lock nut 69 serve to fixedly mount the faucet assembly onto the base plate 71. The mounting stud 67 is inserted through apertures in a first crescent shape metal mounting plate 73, similarly shaped second rubber gasket 75, a generally circular rubber gasket 77 and a third crescent shape rubber gasket 79, all as shown in FIG. 8. It must be understood that other means may be employed for mounting the faucet assembly to a base plate or to some other suitable support with structural integrity.

Mounted on the brass housing 81 is a lock nut 83, a retaining ring 85 and a cartridge 87 seated within said retaining ring 85 and secured by a set screw 89. The cartridge 87 has a central upwardly projecting nipple 91 having an aperture 93 extending at least partially therethrough.

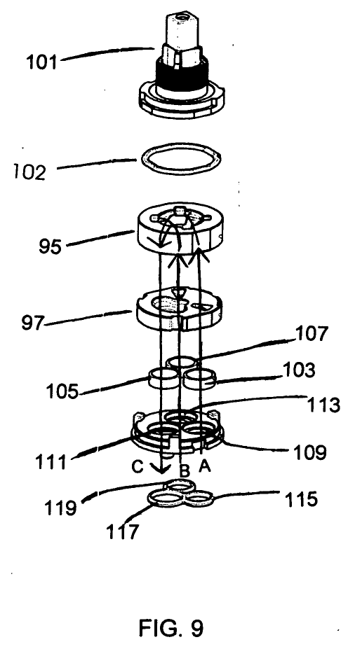

The water flow and its temperature regulation in the faucet assembly of the present invention will now be described by reference to FIGS. 3, 9 and 10. Cold water and hot water enter the faucet through the braided tubes 86 and 88. The water flow is basically controlled by rotating the rotatable plate 95 which is placed in contact on the stationery plate 97. The upper rotatable plate 95 is rotated by rotating plastic figurine 99 (Tigger) which is attached to the lever 101 which is operatively associated with the rotatable plate 95 through the nipple 91, and is sealed by the O-ring 102. The stationery plate 97 is provided with the sealing rings 103, 105, 107 which fit onto the apertures 109, 111 and 113, respectively on the plate 97, and sealed by the sealing gaskets 115, 117 and 119. As it can be seen, when the rotatable plate is rotated the cold water inlet aperture can be partly closed to limit the flow of cold water, and as it is rotated further, this inlet can be closed and the hot water inlet aperture is opened to admit hot water. After the water is mixed in the housing, the water mixture flows out through the inlet aperture and out through the faucet tube 27 at the outlet 45 which is provided with an aerator 93. Arrows A, B and C indicate the directions of flow of the cold water, hot water and the combined hot/cold water.

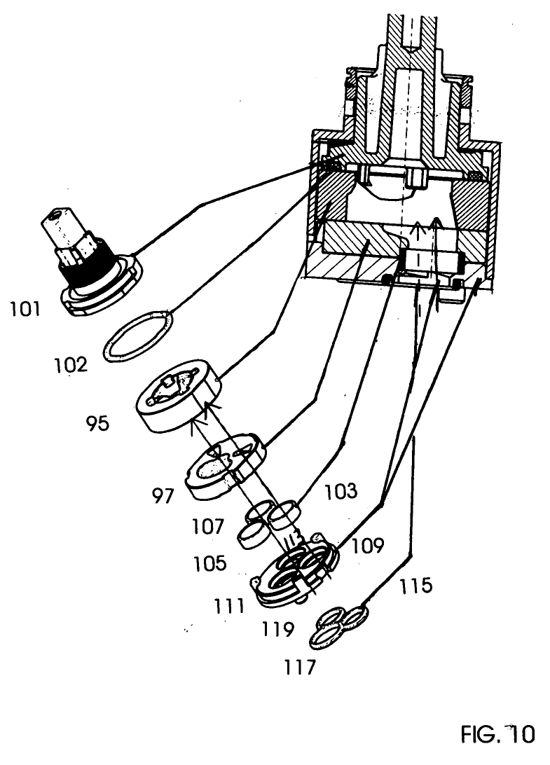

As seen in FIGS. 1, 2, 3 and 8, the plastic toy figurine 99 is fixedly mounted on a rotatable handle 121. In order to rotate the handle, the toy figurine may be gripped by the hand, conveniently between the thumb and the forefinger, and rotated in order to rotate the rotatable plate relative to the stationery plate 95. This results in activation of the lever 101 which rotates the plate 95 relative to the plate. FIG. 10 shows the partially opened apertures which permit the passage of cold water, hot water and the mixture.

As previously mentioned, the functional parts of the faucet assembly of the present invention can be fabricated from parts which are made entirely of plastic but, in accordance with this invention, can be formed of metal onto which is molded onto a suitable plastic, thereby defining a plastic-metal functional part with the plastic forming the exterior surfaces of the functional parts. Suitable plastics are preferably polyvinyl chloride (PVC), acrylonitrile-butadiene-styrene (ABS), high impact polystyrene and nylon.

The plastic components are formed by injection molding under pressure. The plastic parts are then welded onto the metal parts by sonic welding or ultrasonic welding technique. This may be effected by delivering high-power ultrasound energy to the joint/seam area of the plastic and metal. The resulting plastic-metal part thus forms the faucet assembly with the required function but with improved outward aesthetics. In lieu of molding the plastic onto the metal, the joint surfaces of the plastic part and the metal parts may be glued together using super glue or methyl-2-cyanoacrylate which is sold under the trademark Superglue® and Krazy Glue®.

It must be emphasized that the present invention is aimed at providing a faucet assembly wherein various functional parts are plastic covered metals in which the plastic is conformally attached securely to the outer surfaces of the metal part by welding or by a high powered glue of the types known in the art.

1. A faucet assembly comprising
(a) a generally cylindrical body having a base adapted to be secured to a generally flat surface, and having a top rotatable member,
(b) a housing disposed within the top of said cylindrical body,
(c) a first braided tube for conducting cold water and a second braided tube for conducting hot water into said housing,
(d) two plate members retained in said housing, a stationery plate member and a rotatable plate member disposed on top of said stationery member, said stationery plate having a first aperture for passage of cold water into said housing, a second aperture for passage of hot water into said housing, and a third aperture for conducting the mixed water outside of said housing, through a conduit attached to said housing;
(e) means operatively associated with said rotatable plate for rotating said plate such that as to partially or completely close said first aperture and second aperture to regulate the volumes of cold water and hot water which enter said housing, and
(f) a figurine mounted on top of said rotatable handle operatively associated with said rotatable plate to rotate said plate in either direction relative to said stationery plate.

2. A decorative faucet assembly as in claim 1 wherein said figurine is formed of a plastic.

3. A decorative faucet assembly as in claim 2 wherein said cylindrical body and said conduit are formed by molding a plastic onto metal.

4. A decorative faucet assembly as in claim 3 wherein said plastic is integrally attached to the metal by sonic welding.

5. A decorative faucet assembly as in claim 3 wherein said plastic and said metal are adhered together by adhesive glue.

6. A decorative faucet assembly as in claim 3 wherein said plastic is selected from the group consisting of polyvinylchloride (PVC), acrylonitrile-butadiene styrene (ABS) and high impact polystyrene.

7. A decorative faucet assembly as in claim 4 wherein said plastic is selected from the group consisting of polyvinylchloride (PVC), acrylonitrile-butadiene styrene (ABS) and high impact polystyrene.

8. A decorative faucet assembly as in claim 5 wherein said plastic is selected from the group consisting of polyvinylchloride (PVC), acrylonitrile-butadiene styrene (ABS) and high impact polystyrene.
